(19) United States
(12) Patent Application Publication
(10) Pub. No.: US 2024/0416419 A1
(43) Pub. Date: Dec. 19, 2024

(54) HEAT TREATMENT METHOD FOR METAL POWDER

(71) Applicant: KOREA INSTITUTE OF INDUSTRIAL TECHNOLOGY, Cheonan-si (KR)

(72) Inventors: Seung Min YANG, Gangneung-si (KR); Young Kyu JEONG, Hwaseong-si (KR); Ohyung KWON, Gangneung-si (KR); Kyung Hoon KIM, Daejeon (KR); Gun Hee KIM, Incheon (KR)

(21) Appl. No.: 18/698,776

(22) PCT Filed: Oct. 7, 2022
(86) PCT No.: PCT/KR2022/015101

§ 371 Date: Apr. 4, 2024

(30) Foreign Application Priority Data
Oct. 8, 2021 (KR) 10-2021-0134206
Sep. 16, 2022 (KR) 10-2022-0116987

(51) Int. Cl. B22F 9/02; B22F 1/16

(52) U.S. Cl. CPC B22F 9/026; B22F 1/16; B22F 2301/15; B22F 2302/45; B22F 2303/01

(57) ABSTRACT

According to one aspect of the present invention, a heat treatment method for a metal powder is provided. The heat treatment method for a metal powder, according to one embodiment of the present invention, comprises the steps of: preparing a metal powder-anti-sintering agent composite comprising metal powders dispersed and arranged so as to be distanced from each other in an anti-sintering agent; and heat treating the metal powder-anti-sintering agent composite.

### CROSS-REFERENCE TO RELATED APPLICATIONS

This application is the National Stage filing under 35 U.S.C. 371 of International Application No. PCT/KR2022/015101, filed on Oct. 7, 2022, which claims the benefit of Korean Patent Application No. 10-2021-0134206, filed on Oct. 8, 2021 and Korean Patent Application No. 10-2022-0116987, filed on Sep. 16, 2022, the contents of which are all hereby incorporated by reference herein in their entirety.

### FIELD OF INVENTION

The technical idea of the present invention relates to a method for heat treatment of metal powder, and more particularly, to a heat treatment method for preventing aggregation and sintering between particles during high-temperature heat treatment of metal powder to thus offer a uniform particle size.

### BACKGROUND OF INVENTION

Multi-Layer Ceramic Capacitor (MLCC) is a chip-type capacitor to temporarily charge electricity or remove noise in electronic circuits, which is a part of storing current and stably supplying only a required amount of electricity so as to allow an electronic device to be rightly operated. In modern times, the multilayer ceramic capacitor is in demand so much that it is called rice in the electronics industry, for example, about 1000 MLCCs are required for personal computers and smart phones, while needing about 2000 MLCCs for televisions.

Such a multilayer ceramic capacitor needs to be reduced in size and increased in storage capacitance. To this end, the multilayer ceramic capacitor has a structure in which about 500 ceramic layers and metal electrode layers are alternately stacked. The multilayer ceramic capacitor is formed by a molding process of forming a ceramic sheet on a release film, a printing process of forming an electrode pattern on the ceramic sheet, and a lamination process of stacking the ceramic sheet and the metal electrode layer after cutting the ceramic sheet and removing the release film. An important technique in the multilayer ceramic capacitor is to laminate the metal electrode layer as thinly as possible and to form it without cracks even at a high temperature of 1000° C. or higher.

Recently, with miniaturization and high lamination of the multilayer ceramic capacitor, ultra-thin internal electrodes are needed. Further, to keep pace with the continuous miniaturization of the metal electrode layer, additional countermeasures are required.

As parts of such countermeasures, sulfur(S) is added to nickel powder typically used as a material for metal electrode layers, the surface of nickel powder is oxidized, the crystallinity of nickel powder is improved, crystal grains are grown, or heat treatment for various purposes is being performed to remove the sulfur component added during the manufacturing process.

However, such heat treatment is usually implemented at a high temperature, and therefore, a problem in that nickel particles are sintered and agglomerated in a process of performing heat treatment. When nickel particles are sintered, the quality of the nickel powder deteriorates as the particle size increases and the shape becomes irregular. This problem is not limited to nickel powder but is a general problem that may occur in the case of heat-treating conventional metal powder at high temperature.

### Summary of Invention

### Technical Problem to be Solved

A technical task to be achieved by the technical idea of the present invention is to provide a heat treatment method for preventing aggregation due to sintering between metal powders during high-temperature heat treatment of various metal powders including nickel powder. However, this task is exemplary, and the technical spirit of the present invention is not limited thereto.

### Technical Solution

According to one aspect of the present invention, a heat treatment method for metal powder is provided.

According to one embodiment of the present invention, the heat treatment method of the metal powder may include: a step of preparing a metal powder-anti-sintering agent composite that includes metal powders dispersed and disposed spaced apart from one another inside the anti-sintering agent; and a step of heat-treating the metal powder-anti-sintering agent composite.

According to one embodiment of the present invention, the anti-sintering agent may include a metal salt, wherein the metal salt may include metal chloride, for example, the metal chloride may include NiCl₂, BaCl₂. NaCl, and KCl.

According to one embodiment of the present invention, the metal powder may include any one or more of nickel powder, copper powder, silver powder, iron powder, and alloy powder thereof.

According to one embodiment of the present invention, the anti-sintering agent may further include a ceramic precursor that is converted into ceramic by heat along with a metal salt, wherein the ceramic precursor may include Al(NO₃)₃, Al₂(SO₄)₃, Ba(NO₃)₂, TiCl₄, and Mg(NO₃)₂.

According to one embodiment of the present invention, the heat treatment may include converting the ceramic precursor into ceramic.

According to one embodiment of the present invention, the manufacturing method of the metal powder-anti-sintering agent composite may include: preparing an anti-sintering agent solution in which the anti-sintering agent is dissolved in a solvent; preparing a metal powder dispersion by adding and then dispersing metal powder into the anti-sintering agent solution; and spray-drying the dispersed particle dispersion.

According to one embodiment of the present invention, a step of removing the anti-sintering agent may be further included after the heat treatment.

According to an embodiment of the present invention, the heat treatment may be conducted in an atmosphere including any one of: hydrogen atmosphere; oxidation atmosphere; carbonization atmosphere; decarburization atmosphere; reduction atmosphere; inert atmosphere; air atmosphere; sulfurization atmosphere; desulfurization atmosphere; and vacuum atmosphere.

According to an embodiment of the present invention, after the heat treatment is completed, a step of recovering the metal powder by removing the anti-sintering agent may further be included, wherein ceramic converted from the ceramic precursor in the step of removing the anti-sintering agent may remain on at least a part of the surface of the recovered metal powder.

### Effect of Invention

According to the technical idea of the present invention, sintering between the metal powders is suppressed by the anti-sintering agent during heat treatment of the metal powders at high temperature, whereby a problem of aggregation of the metal powders does not occur. Further, as the ceramic precursor included in the anti-sintering agent is converted into ceramic in the heat treatment process and remains on the surface of the metal powder in the removal step of the anti-sintering agent, resistance to sintering shrinkage can be improved if the metal powder is further used in the manufacture of a metal electrode layer of MLCC.

The effects of the present invention described above have been described by way of example, and the scope of the present invention is not limited thereby.

### BRIEF DESCRIPTION OF DRAWINGS

FIG. 1 is a flow chart showing a metal powder heat treatment method according to the technical idea of the present invention.

FIG. 2A shows the results of observing the prepared nickel powder by SEM.

FIG. 2B shows the results obtained by observing the nickel particle-anti-sintering agent composite using NiCl₂ as anti-sintering agents by SEM.

FIG. 2C show the results obtained by observing the nickel particle-anti-sintering agent composite using BaCl₂ as anti-sintering agents by SEM.

FIG. 3 illustrates the results of observing the state after heat treatment of control group 1 to control group 4 by SEM.

FIG. 4 illustrates the results of observing the state after heat treatment (upper picture) and the state of nickel powder recovered after removing the sintering agent (lower picture) of Experimental Groups 3 and 4 by SEM.

FIG. 5 illustrates the results of observing the state of the recovered nickel powder after removing all the anti-sintering agents of the heat-treated nickel powder-anti-sintering agent composite by SEM and performing component analysis with EDS.

FIG. 6A shows the result of measuring a final oxidation termination temperature by observing a weight increase due to oxidation in the air using TGA for CVS nickel powder without any post-treatment.

FIG. 6B shows TGA analysis result using nickel powder recovered after post-treatment corresponding to experimental group 9.

FIG. 7 shows a structure of the metal powder-anti-sintering agent composite obtained by spray drying treatment.

### DETAILED DESCRIPTION OF PREFERRED EMBODIMENTS OF INVENTION

Hereinafter, preferred embodiments of the present invention will be described in detail with reference to the accompanying drawings. The embodiments of the present invention are provided to more completely explain the technical idea of the present invention to those skilled in the art, and the following examples may be modified in various different forms, and the scope of the technical idea is not limited to the following examples. Rather, these embodiments are provided so that this disclosure will be thorough and complete, and will fully convey the spirit of the invention to those skilled in the art. Like reference numerals throughout this specification mean like elements. Furthermore, various elements and areas in the drawings are schematically drawn. Therefore, the technical spirit of the present invention is not limited by the relative size or spacing drawn in the accompanying drawings.

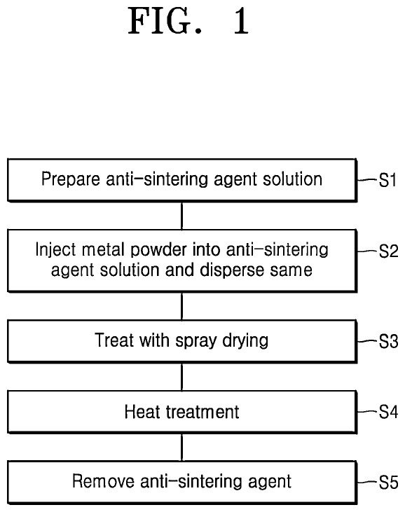

FIG. 1 shows a proposal method for heat treatment of metal powder, including preparing a metal powder-anti-sintering agent composite according to an embodiment of the present invention, and then, heat-treating the metal powder using the same.

Referring to step S1 of FIG. 1, a step of dissolving an anti-sintering agent in a solvent to form an anti-sintering agent solution may be conducted. The anti-sintering agent may be a material that is dissolved in a solvent and then precipitated again in the spray-drying step described later. The solvent may be water or an organic solvent.

The anti-sintering agent may include a metal salt, and the metal salt may include, for example, metal chlorides such as NiCl₂, BaCl₂. NaCl, and KCl.

The anti-sintering agent may further include a ceramic precursor together with a metal salt. The ceramic precursor may be a material that is converted into ceramic by thermal decomposition during a subsequent heat treatment process. The ceramic may include metal oxide, metal nitride, metal carbide, and composites thereof (e.g., metal oxynitride). For example, the metal oxide may include aluminum oxide (Al₂O₃) and barium titanium oxide (BaTiO₃). For example, aluminum nitrate (Al(NO₃)₃) or aluminum sulfate (Al₂(SO₄)₃) as a precursor of aluminum oxide, barium nitrate (Ba(NO₃)₂) and titanium chloride (TiCl₄) as a precursor of barium titanium oxide, and magnesium nitrate (Mg(NO₃)₂) as a precursor of magnesium oxide may be included.

An anti-sintering agent soluble in a solvent may be a metal salt. Alternatively, the metal salt and the ceramic precursor may be dissolved together. When the metal salt and the ceramic precursor are dissolved together in a solvent, the anti-sintering agent precipitated in the spray-drying step may be precipitated as a mixture in which the metal salt and the ceramic precursor are mixed with each other.

Referring to step S2 of FIG. 1, a metal powder dispersion is prepared by adding metal powder to a solution in which an anti-sintering agent is dissolved, and then, dispersing the same in the solution.

The metal powder may include, but is not limited to, for example, nickel powder, copper powder, silver powder, nickel-copper alloy powder, iron powder, and alloy powders thereof (e.g., nickel-copper alloy powder, iron-cobalt alloy powder, etc.).

Referring to step S3 of FIG. 1, a metal powder-anti-sintering agent composite is prepared through spray-drying for the metal powder dispersion. In the spray-drying process, the metal powder dispersion may be sprayed and atomized, and then dried using hot air to instantly evaporate the liquid phase so as to obtain a powder grain phase (hereinafter referred to as a metal powder-anti-sintering agent composite) containing metal powder and anti-sintering agent.

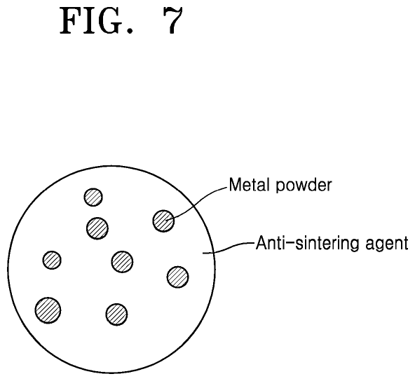

FIG. 7 shows the structure of the metal powder-anti-sintering agent composite obtained through spray-drying. Referring to FIG. 7, the metal powder-anti-sintering agent composite may have a structure in which a plurality of metal powders (metal particles) are spaced apart from one another and dispersed inside the anti-sintering agent.

The anti-sintering agent may be formed by precipitating a metal salt dissolved in a solution or a mixture of a metal salt and a ceramic precursor as solids in the spray-drying step. More particularly, the anti-sintering agent may be formed while surrounding the metal powder in the precipitation process.

In some cases, the anti-sintering agent may include ceramics formed as a part of the ceramic precursor is converted during the spray-drying process.

As shown in FIG. 7, in the metal powder-anti-sintering agent composite prepared according to an embodiment of the present invention, the anti-sintering agent surrounds the metal powder so that the metal powders are physically disposed while being spaced apart from one another. Therefore, even if the metal powder-anti-sintering agent composite is heat-treated at a high temperature, it is possible to prevent the metal powders from contacting one another, which in turn are sintered and aggregated in the heat treatment process, since the contact between the metal powders is blocked by the anti-sintering agent.

Referring to step S4 of FIG. 1, after forming the metal powder-anti-sintering agent composite through spray-drying, a step of heat-treating the metal powder-anti-sintering agent composite may be further conducted.

The heat treatment is a heating process performed to improve or modify the properties of the metal powder. Illustratively, in the case of nickel powder, heat treatment may be performed for the purpose of injecting sulfur on the surface or oxidizing the surface in order to inhibiting sintering and shrinkage of the nickel powder in the MLCC manufacturing process. As another example, heat treatment may be performed in a vacuum or inert atmosphere in order to improve the crystallinity of the nickel powder. As another example, heat treatment may be performed in a desulfurization atmosphere to desulfurize the sulfur component added to the nickel powder in the process of preparing the nickel powder by the chemical vapor method.

Further, various atmospheres such as reduction atmosphere, oxidation atmosphere, vacuum atmosphere, and inert atmosphere for modifying other metal powders other than nickel powder may be used.

During such heat treatment, sintering between the nickel powders does not occur due to an anti-sintering agent.

On the other hand, the anti-sintering agent formed by the spray-drying process may contain a minute space in which gas can move inside, and therefore, when heat-treated in an oxygen atmosphere or a sulfur atmosphere, a reaction gas such as oxygen gas or sulfur gas may flow through the anti-sintering agent and reach the metal powder inside the anti-sintering agent.

When the ceramic precursor is included in the anti-sintering agent, the ceramic precursor may be converted into ceramic during the heat treatment process. In this case, when the heat treatment is completed, the anti-sintering agent of the metal powder-anti-sintering agent composite may contain the ceramic converted from the ceramic precursor together with a metal salt.

The ceramic formed by the conversion from the ceramic precursor may serve to further improve anti-sintering properties of the anti-sintering agent. Further, in some cases, the ceramic may remain on the surface of the metal powder even after the step of removing the anti-sintering agent, and may affect characteristics of the metal powder.

For example, when the metal powder is nickel powder, aluminum oxide, magnesium oxide, barium titanium oxide or a precursor of barium titanium oxide may remain as the ceramic on the surface of the nickel powder. As such, if the ceramic remains on the surface of the nickel powder, an effect of suppressing abnormal growth of the nickel powder due to sintering at a high temperature may be obtained when the nickel power is used as an MLCC electrode.

The heat treatment may have a section maintained at a predetermined temperature for a predetermined time according to the purpose. When the ceramic precursor is included in the anti-sintering agent, the heat treatment temperature may be raised above a pyrolysis temperature of the ceramic precursor.

As another example, the heat treatment may be performed during a process of continuously raising the temperature. In this case, it is not maintained at a specific temperature for a predetermined time, but the ceramic precursor may be converted into ceramic while raising the temperature to the heat treatment temperature.

Referring to step S5 of FIG. 1, the metal powder-anti-sintering agent composite after the heat treatment may be selectively removed through a washing process to recover the metal powder.

The anti-sintering agent may be removed by washing the same with a cleaning solution capable of dissolving the anti-sintering agent. For example, when the anti-sintering agent contains water-soluble metal chloride such as NiCl₂ or BaCl₂, it can be washed with water to dissolve and remove all of them. Other organic solvents or acid/alkali solutions may also be used as cleaning solutions.

Hereinafter, experimental results are presented to aid understanding of the present invention. These experimental results are exemplary to aid understanding of the present invention, and the present invention is not limited thereto.

### 1st Experiment

As the metal powder, nickel powder (average diameter of 200 nm class) prepared by chemical vapor synthesis using NiC₂ and H₂ as raw materials was used.

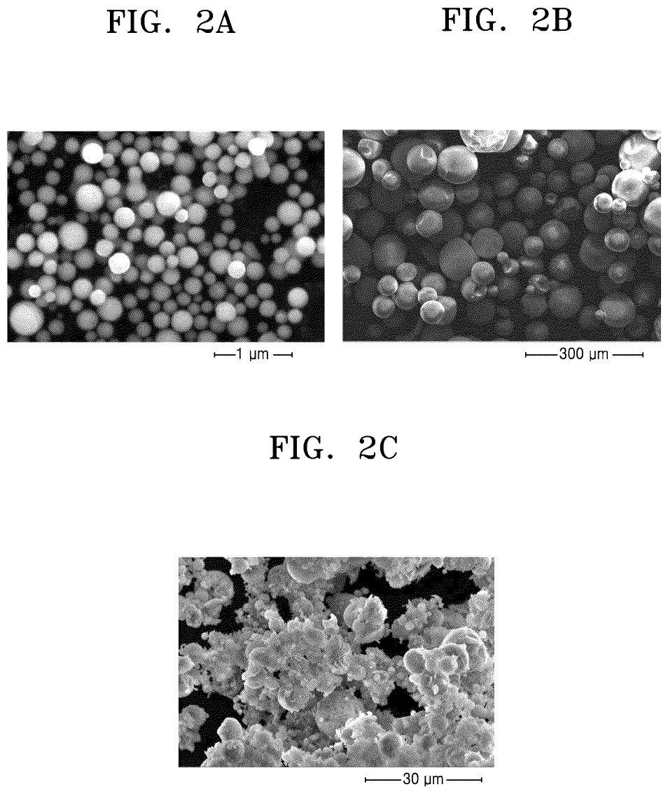

FIG. 2A shows the results of observing the prepared nickel powder by SEM.

Metal salts NiCl₂ and BaCl₂ were used as anti-sintering agents. An anti-sintering agent solution was prepared by dissolving 207.6 g of each of NiCl₂ and BaC₂ in 450 ml of water. A metal powder dispersion was prepared by adding nickel powder to each of the prepared anti-sintering agent solutions. The metal powder dispersion was spray-dried at 180° C. to prepare a metal powder-anti-sintering agent composite.

FIGS. 2B and 2C show the results obtained by observing the nickel particle-anti-sintering agent composite using NiCl₂ and BaCl₂ as anti-sintering agents by SEM, respectively. Referring to the above results, it could be seen that the nickel particles are well dispersed in the anti-sintering agents NiCl₂ and BaCl₂. As a result of analyzing the components of the anti-sintering agent using EDS (energy dispersive spectroscopy), Ni and Cl were detected in the specimen of FIG. 2B and Ba and Cl were detected in the specimen of FIG. 2C, thereby confirming that the anti-sintering agent was normally produced.

After heat-treating the prepared metal powder-anti-sintering agent composite in hydrogen (H₂) or oxygen (O₂) atmosphere, the presence or absence of sintering of the metal powder, the crystal grain size and the content of nickel oxide (NiO) were measured. Table 1 shows the types of specimens performed in the first experiment and the post-treatment experimental conditions according to the same.

TABLE 1

| | | | | | Heat | | Crystal | |
|---|---|---|---|---|---|---|---|---|
| | | | | | treatment | | grain | NiO |
| | | Post- | Metal | | temperature | | size | content |
| Type | No. | treatment | salt | atmosphere | (° C.) | Sintering | (nm) | (wt. %) |
| Control | 1 | ◯ | X | H₂ | 300 | X | 53.41 | |
| group | 2 | | | | 400 | ◯ | 64.31 | |
| | 3 | | | | 500 | | 67.25 | |
| | 4 | | | | 600 | | 118.2 | |
| Experimental | 1 | | BaCl₂ | | 300 | X | 51.02 | |
| group | 2 | | | | 400 | | 60.04 | |
| | 3 | | | | 500 | | 63.2 | |
| | 4 | | | | 600 | | 67.25 | |
| | 5 | | NiCl₂ | O₂ | 400 | | 60.05 | 14.00 |
| | 6 | | | | 500 | | 70.62 | 25.20 |

In Table 1, the control groups 1 to 4 were heat-treated nickel powder (hereinafter referred to as CVS nickel powder) without forming an anti-sintering agent by temperature in the hydrogen atmosphere, wherein the above treatment was proceeded to confirm that the nickel powder was sintered according to the temperature.

Experimental groups 1 to 4 were nickel particle-anti-sintering agent composites, in which the anti-sintering agent is BaCl₂, heat-treated by temperature in the hydrogen atmosphere, wherein the above treatment was proceeded to improve the crystal grain size of nickel powder while preventing aggregation.

Experimental groups 5 to 6 were nickel particle-anti-sinter composites, in which the anti-sintering agent is NiCl₂, heat-treated by temperature in the oxygen atmosphere, wherein the above treatment was proceeded to perform oxidative heat treatment of the nickel powder while preventing aggregation.

In the heat treatment, the temperature was raised from room temperature to the heat treatment temperature for 40 minutes, maintained at the heat treatment temperature for 5 minutes, followed by cooling in a furnace.

The nickel particle-anti-sintering agents of the control and experimental groups after heat treatment were washed with water to remove all anti-sintering agents, and nickel powder was recovered.

Referring to Table 1, in the case of the control group, sintering between nickel powders did not occur because the temperature was too low if it is 300° C., but sintering occurred at all higher temperatures.

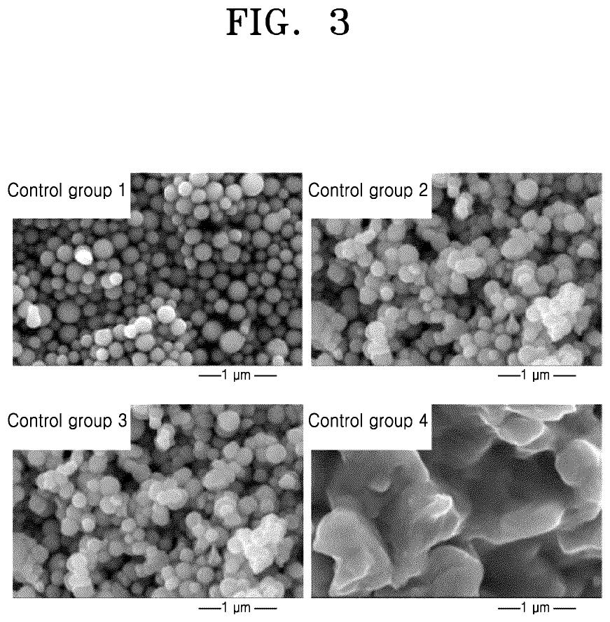

FIG. 3 illustrates the result of observing the state after heat treatment of control group 1 to control group 4 by SEM. Referring to FIG. 3, it could be seen that sintering of the nickel powder occurs actively from 400° C. or higher, and aggregation between particles occurs due to sintering, accompanied by severe changes in shape.

Referring to Table 1, it could be seen that sintering did not occur at all temperatures of the experimental groups 1 to 4, and the grain size increased with increased heat treatment temperature. At this time, the crystal grain size was measured by X-ray diffraction.

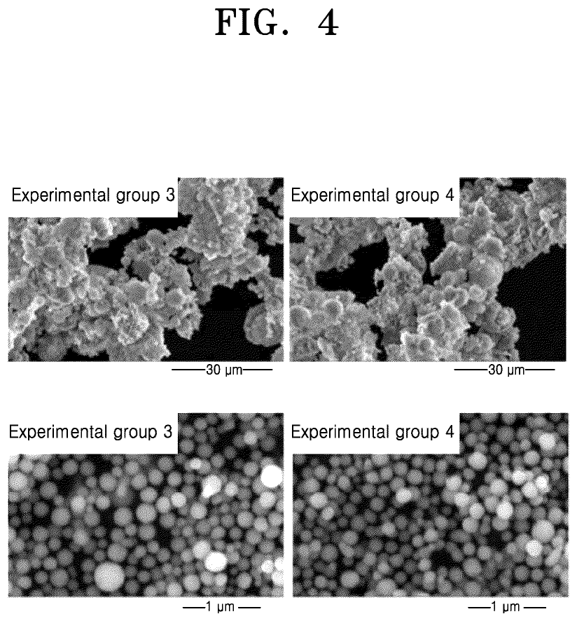

FIG. 4 shows the representative results of SEM observation of the state before removing the anti-sintering agent after heat treatment of experimental groups 3 and 4 (upper picture) and the state of the recovered nickel powder after removing the anti-sintering agent (lower picture). Referring to FIG. 4, it could be confirmed that the contact between the nickel powders and the sintering of the nickel powders were prevented by BaCl₂ as an anti-sintering agent in all of the experimental groups 3 and 4.

Referring to Table 1, in experimental groups 5 to 6, sintering did not occur at all temperatures, and it could also be confirmed that the crystal grain size of the nickel powder increased with increased heat treatment temperature. Further, as a result of X-ray diffraction analysis, it was confirmed that nickel oxide (NiO) was formed. Through this, according to the technical idea of the present invention, it could be confirmed that nickel oxide having high crystallinity may be formed on the surface of nickel particles at a high temperature while preventing sintering between metal powders.

### 2nd Experiment

Table 2 shows the types of specimens in the second experiment and the experimental conditions according to the same. 207.6 g of BaCl₂ as a metal salt, and 0.19 g of Al(NO₃)₃ as a precursor of aluminum oxide were dissolved in 450 ml of water, and 5 g of CVS nickel powder used in the first experiment was added thereto and dispersed. The metal powder dispersion was spray-dried at 180° C. to prepare a nickel particle-anti-sintering agent composite. As a result of analyzing the anti-sintering agent by EDS, Ba, Al and Cl components were detected, and it could be confirmed from the result that the anti-sintering agent is a mixture of BaCl₂ and Al(NO₃)₃.

TABLE 2

| | | | | | Heat | |
|---|---|---|---|---|---|---|
| | | | Metal | | treatment | |
| | | Post- | salt + ceramic | | temperature | |
| Type | No, | treatment | precursor | atmosphere | (° C.) | Sintering |
| Experimental | 7 | ◯ | BaCl₂ + | H₂ | 300 | X |
| group | 8 | | Al(NO₃)₃ | | 400 | |
| | 9 | | | | 500 | |

Then, it was put into a heat treatment furnace and heat treatment was performed in a hydrogen atmosphere. Heat treatment temperatures were 300, 400 and 500° C. Heat treatment conditions from elevated temperature to furnace cooling were the same as in the first experiment.

As a result of EDS analysis of the nickel particle-anti-sintering agent composite specimens of experimental groups 7 to 9 after heat treatment, Ba, Al and Cl components were detected in all specimens. Further, as a result of X-ray diffraction analysis, aluminum oxide (Al₂O₃) was detected in all specimens. This means that Al(NO₃)₃ having a thermal decomposition temperature of about 200° C. in the anti-sintering agent during the heat treatment process was thermally decomposed at a temperature of 300° C. or higher and converted into aluminum oxide. Therefore, after heat treatment, the anti-sintering agent of the nickel particle-anti-sintering agent composite is a mixture of BaCl₂ and Al₂O₃ and, when an amount of Al(NO₃)₃ added during the preparation of the anti-sintering agent solution is calculated, it could be confirmed that the anti-sintering agent contains Al₂O₃ in an amount of about 10 wt %.

The anti-sintering agent was removed and nickel powder was recovered by washing the nickel particle-anti-sintering agent composites of Experimental Groups 7 to 9 with water after heat treatment. As a result of observing the recovered nickel powder by SEM, it was confirmed that sintering did not occur in all nickel powders regardless of the heat treatment temperature.

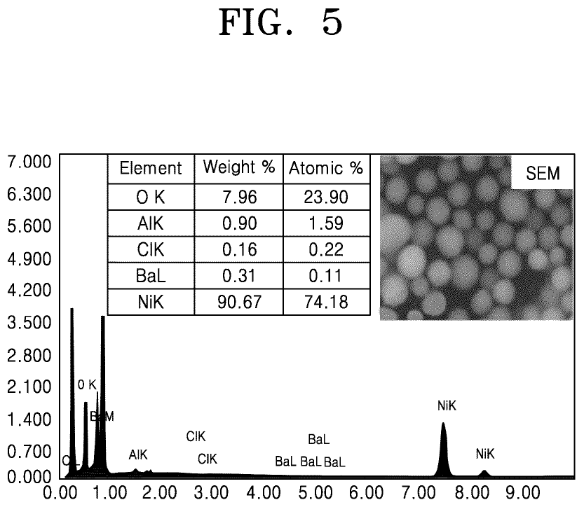

FIG. 5 shows the state of the nickel powder recovered after post-treatment corresponding to Experimental Group 9, that is, a result of SEM observation of the state of nickel powder, which was recovered after washing the nickel particle-anti-sintering agent composite with water after completing 500° C. heat treatment to remove all of the anti-sintering agent, followed by component analysis through EDS.

Referring to FIG. 5, it could be confirmed that aluminum components are also detected in the recovered nickel powder. This suggests that aluminum oxide formed from the precursor during heat treatment is also formed on the surface of the nickel particle and remains on the surface of the nickel particle even after the removal of the anti-sintering agent.

In this way, if high melting point aluminum oxide is formed on the nickel surface, it means that occurrence of problems due to sintering shrinkage is reduced by high resistance of nickel powder to sintering shrinkage during MLCC manufacturing process.

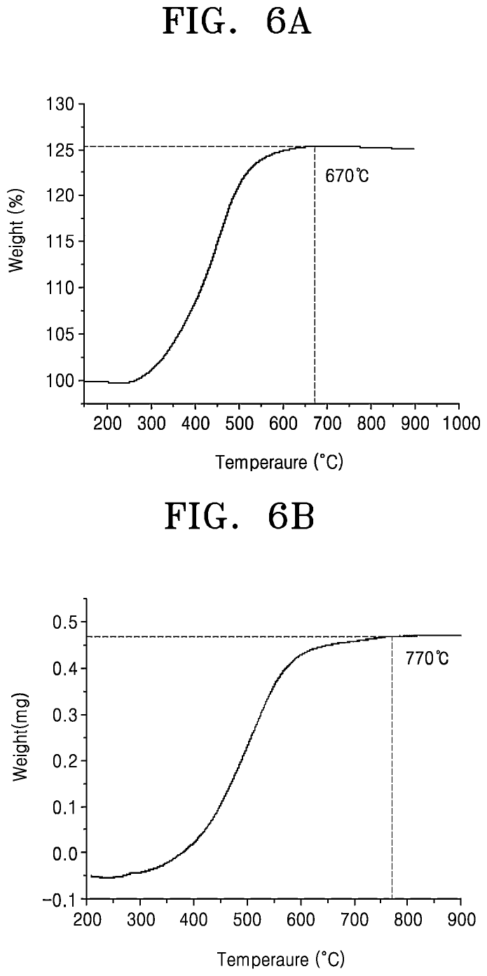

FIG. 6A shows the result of measuring a final oxidation termination temperature by observing a weight increase due to oxidation in the air using TGA for CVS nickel powder without any post-treatment. FIG. 6B shows TGA analysis result using nickel powder recovered after post-treatment corresponding to experimental group 9.

Referring to FIGS. 6A and 6B, in the case of the CVS nickel powder without post-treatment, an oxidation terminal temperature was 670° C., whereas the nickel powder recovered after post-treatment corresponding to Experimental Group 9 showed an oxidation termination temperature of 770° C., which is about 100° C. higher than the above case. It could be seen that the higher the temperature at which oxidation terminates, the higher the sintering temperature in the sintering process in the MLCC manufacturing process, which means that the resistance to sintering shrinkage is higher.

The technical spirit of the present invention described above is not limited to the foregoing embodiments and the accompanying drawings, and it will be clear to those skilled in the art to which the present invention pertains that various substitutions, modifications and changes are possible within the scope of the technical spirit of the present invention.

1-14. (canceled)

15. A method for heat treatment of metal powder, comprising:
preparing a metal powder-anti-sintering agent composite that includes metal powders dispersed and disposed spaced apart from one another inside the anti-sintering agent; and
heat-treating the metal powder-anti-sintering agent composite.

16. The method according to claim 15, wherein the preparation of the metal powder-anti-sintering agent composite includes:
preparing an anti-sintering agent solution in which the anti-sintering agent is dissolved in a solvent;
preparing a metal powder dispersion by adding and then dispersing the metal powder into the anti-sintering agent solution; and
spray-drying the dispersed particle dispersion.

17. The method according to claim 15, further comprising removing the anti-sintering agent from the meal-anti-sintering agent composite to recover the metal powder after the heat treatment step is conducted.

18. The method according to claim 17, wherein the removal of the anti-sintering agent is performed by washing the metal powder-anti-sintering agent composite with a washing solution capable of dissolving the anti-sintering agent.

19. The method according to claim 15, wherein the heat treatment step is conducted in an atmosphere including any one of: hydrogen atmosphere; oxidation atmosphere; carbonization atmosphere; decarburization atmosphere; reduction atmosphere; inert atmosphere; air atmosphere; sulfurization atmosphere; desulfurization atmosphere; and vacuum atmosphere.

20. The method according to claim 15, wherein the anti-sintering agent includes a ceramic precursor to be converted into ceramic by heat.

21. The method according to claim 20, wherein the ceramic precursor is converted into ceramic in the heat treatment step.

22. The method according to claim 20, wherein, after the heat treatment is conducted, the ceramic converted from the ceramic precursor remains on at least a part of the surface of the metal powder recovered by removing the anti-sintering agent.

23. The method according to claim 20, wherein the ceramic precursor includes at least any one among metal oxide, metal nitride, metal oxynitride, metal sulfide, metal chloride and combination thereof.

24. The method according to claim 20, wherein the ceramic precursor includes at least any one among Al(NO₃)₃, Al₂(SO₄)₃, Ba(NO₃)₂, TiCl₄, and Mg(NO₃)₂.

25. The method according to claim 15, wherein the anti-sintering agent includes a metal salt.

26. The method according to claim 15, wherein the anti-sintering agent includes metal chloride.

27. The method according to claim 15, wherein the anti-sintering agent includes at least any one among NiCl₂, BaCl₂, NaCl, and KCl.

28. The method according to claim 15, wherein the metal powder includes at least any one among nickel powder, copper powder, silver powder, iron powder, cobalt powder and alloy powder thereof.
